(19) United States
(12) Patent Application Publication
(10) Pub. No.: US 2011/0115831 A1
(43) Pub. Date: May 19, 2011

(54) MULTIVISION DISPLAY DEVICE AND DRIVING METHOD THEREFOR

(75) Inventor: Hae-Kwan Seo, Yongin-City (KR)

(73) Assignee: SAMSUNG MOBILE DISPLAY CO., LTD., Yongin-City (KR)

(21) Appl. No.: 12/868,238

(22) Filed: Aug. 25, 2010

(30) Foreign Application Priority Data
Nov. 17, 2009 (KR) 10-2009-0110782

(51) Int. Cl. G09G 5/10; G09G 5/00

(52) U.S. Cl. 345/690; 345/1.3

(57) ABSTRACT

A multivision display device in which adjacent display panels are partially overlapped with each other, so that portions at which an image is inconsecutive are not produced on a screen, and a driving method for the multivision display device. The multivision display device includes a first display panel and a second display panel. The first display panel has a first light emitting area and a first non-light emitting area formed around the first light emitting area. The second display panel has a second light emitting area and a second non-light emitting area formed around the second light emitting area. In the multivision display device, the first and second non-light emitting areas are overlapped with each other so that the first and second light emitting areas are adjacent to each other about a reference line.

### CLAIM OF PRIORITY

This application makes reference to, incorporates the same herein, and claims all benefits accruing under 35 U.S.C. §119 from an application entitled MULTIVISION AND DRIVING METHOD THEREFOR earlier filed in the Korean Intellectual Property Office on Nov. 17, 2009 and there duly assigned Serial No. 10-2009-0110782.

### BACKGROUND OF THE INVENTION

1. Field of the Invention

An aspect of the present invention relates to a multivision display device and a driving method therefor, and more particularly, to a multivision display device in which a plurality of display panels are partially overlapped with each other, so that one image can be expressed as a large screen, and a driving method for the multivision display device.

2. Description of the Related Art

In a flat panel display device, a display area is defined by arranging a plurality of pixels in a matrix form, and a scan line and a data line are connected to each of the pixels to selectively supply a data signal to each of the pixels, thereby displaying an image.

### SUMMARY OF THE INVENTION

In one embodiment, there are provided a multivision display device in which adjacent display panels are partially overlapped with each other, so that portions at which an image is inconsecutive are not produced on a screen, and a driving method for the multivision display device.

According to an aspect of the present invention, there is provided a multivision display device including a first display panel having a first light emitting area and a first non-light emitting area formed around the first light emitting area; and a second display panel having a second light emitting area and a second non-light emitting area formed around the second light emitting area, wherein the first and second non-light emitting areas are overlapped with each other so that the first and second light emitting areas are adjacent to each other about a reference line.

According to another aspect of the present invention, there is provided a driving method for a multivision display device, which includes supplying an image signal to a display panel, the display panel including a first display panel having a first light emitting area and a first non-light emitting area, and a second display panel having a second light emitting area and a second non-light emitting area; partially overlapping the first and second display panels, thereby forming a first area on the first display panel; determining a degree at which the luminance of the first area is reduced by the second display panel, thereby generating a correction value of the image signal; and generating a data signal using the image signal having the generated correction value applied thereto.

In a multivision display device and a driving method therefor according to the present invention, display panels are partially overlapped with each other, and therefore pixels of the display panels are adjacent to each other. Accordingly, the display panels are recognized as one panel, so that portions at which an image is inconsecutive are not produced on a large screen of the multivision display device.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a sectional view illustrating the structure of a display panel in a multivision display device according to an embodiment of the present invention;

FIG. 2 is a flowchart illustrating the drive of the display panel illustrated in FIG. 1;

FIG. 3 is a block diagram illustrating the structure of the multivision display device according to an embodiment of the present invention; and

FIG. 4 is a circuit diagram of a pixel used in the multivision display device according to the embodiment of the present invention.

### DETAILED DESCRIPTION OF THE INVENTION

In a flat panel display device, a display area is defined by arranging a plurality of pixels in a matrix form, and a scan line and a data line are connected to each of the pixels to selectively supply a data signal to each of the pixels, thereby displaying an image.

Flat panel display devices are divided into passive matrix light emitting display devices and active matrix light emitting display devices based on the driving method of pixels. The active matrix light emitting display devices for turning on/off each pixel are frequently used in view of resolution, contrast and operating speed.

Such flat panel display devices are used as display devices for personal computers, mobile phones, personal digital assistants (PDAs) and the like, or monitors for various types of information devices. The flat panel display devices include a liquid crystal display device (LCD) using an LCD panel, an organic light emitting display device using an organic light emitting element, a plasma display panel (PDP) using a plasma panel, and the like.

Recently, there have been developed various types of light emitting display devices having a lighter weight and a smaller volume than cathode ray tubes (CRTs). Particularly, organic light emitting display devices have come into the spotlight, which have high light-emitting efficiency and luminance, wide viewing angle and fast response speed.

However, the organic light emitting display devices have difficulty in implementing a large screen. Therefore, a large screen may be implemented in the form of a multivision display device in which a plurality of small screens are connected to one another. However, each of the organic light emitting display devices constituting the multivision display device is divided into a display area in which an image is expressed and a non-display area in which the image is not expressed, and the organic light emitting display devices are spaced apart from one another at a predetermined interval. Therefore, portions at which an image is not consecutive in a large screen are necessarily produced.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

FIG. 1 is a sectional view illustrating the structure of a display panel in a multivision display device according to an embodiment of the present invention.

Referring to FIG. 1, the display panel 100 in the multivision display device includes a first display panel 110 and a second display panel 120. The first and second display panels 110 and 120 are connected to each other by a hinge (not shown) so that they can be rotated about the hinge. Each of the first and second display panels 110 and 120 is covered with a transparent sealing substrate (not shown). Thus, although the first and second display panels 110 and 120 are partially overlapped with each other, light emitting areas 110b and 120b for expressing images are formed by the sealing substrates on substrates 110a and 120a in the first and second display panels 110 and 120, respectively. At this time, the area at which an image is not expressed around each of the light emitting areas 110b and 120b may be referred to as a non-light emitting area.

In the multivision display device, if the first and second display panels 110 and 120 are horizontal to each other by the rotation of the hinge, the non-light emitting area of the second display panel 120 is positioned on the light emitting area 110b of the first display panel 110. Thus, the light emitting areas 110b and 120b of the first and second display panels 110 and 120 come in contact with each other about reference line L, so that pixels positioned at the outermost line in the light emitting area of the first display panel 110 are adjacent to pixels positioned at the outermost line in the light emitting area 120b of the second display panel 120.

For this reason, portions at which an image is not consecutive are not produced on a screen of the multivision display device.

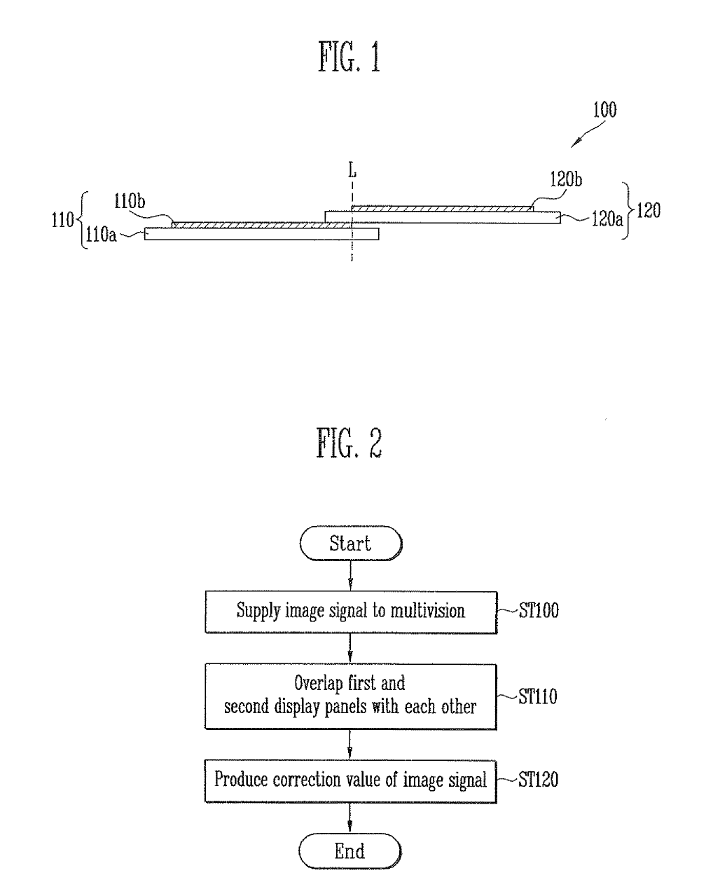

However, if display panels are partially overlapped with each other as described above, light emitted from a light emitting area passes through a non-light emitting area, and hence, luminance may be reduced. Therefore, such a reduction of luminance is necessarily solved. The reduction of luminance will be described in the following FIG. 2.

FIG. 2 is a flowchart illustrating the drive of the display panel illustrated in FIG. 1.

Referring to FIG. 2, in order to solve the reduction of luminance, an image is first expressed by supplying an image signal to the display panel 100 (ST100). Then, the first and second display panels 110 and 120 are rotated to be horizontal to each other so that they are partially overlapped with each other (ST110).

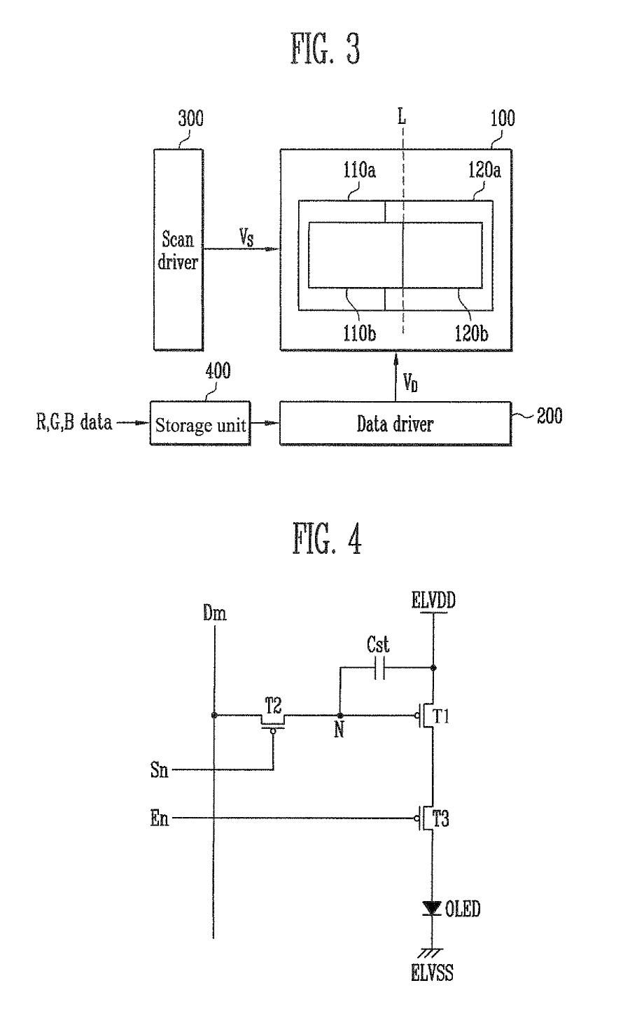

In the display panel 100, the area overlapped by the non-light emitting area of the second display panel 120 on the first display panel 110 is referred to as a first area, and the area that is not overlapped with the non-light emitting area of the second display panel 120 is referred to as a second area, as will be further explained with respect to FIG. 3.

It is then determined whether or not the luminance of the first area is reduced. The correction value of the image signal is produced by determining a degree at which the luminance of the first area is reduced (ST120). The correction value of the image signal is stored in a storage unit 400 (FIG. 3) so as to be applied when a data signal is generated using the image signal. If the data signal generated by applying the correction value to the image signal is inputted to the display panel 100, the data signal inputted to the first area is not changed, but the data signal inputted to the second area has luminance reduced based on the correction value. Thus, the difference in luminance between the first and second areas is decreased.

When a low gray scale is expressed in the first area, the correction value of the image signal is not applied. This is because, although the reduction of luminance is produced at the low gray scale, it is difficult to recognize the reduction of luminance Therefore, a reference gray scale based on which the correction value is applied to the image signal is determined. If an image signal having a higher gray scale than the reference gray scale is inputted, the correction value is applied to the image signal. If an image signal having a lower gray scale than the reference gray scale is inputted, the correction value is not applied to the image signal. The reference gray scale may be arbitrarily determined by a designer.

FIG. 3 is a block diagram illustrating the structure of the multivision display device according to an embodiment of the present invention.

Referring to FIG. 3, the multivision display device includes a display panel 100 having a first display panel 110 and a second display panel 120; a data driver 200 for supplying a data signal V_{D} to the display panel 100; a scan driver 300 for supplying a scan signal V_{S} to the display panel 100; and a storage unit 400 for storing the correction value of an image signal.

The display panel 100 receives an image signal supplied from the exterior thereof to express an image. At this time, the first and second display panels 110 and 120 form one screen.

The luminance expressed at a first area is set lower than that expressed at a second area by the data signal V_{D} outputted from the data driver 200. In the first area, a light emitting area of the first display panel 110 is overlapped with a non-light emitting area of the second display panel 120. In the second area, the light emitting area of the first display panel 110 is not overlapped with the non-light emitting area of the second display panel 120. That is, it is assumed that the luminance of the first area is reduced by about 20% due to the overlapping. Then, if the luminance of the first area is set as 230 cd/m², the luminance of the second area is set as 184 cd/m², which is lower by about 20% than that of the first area.

The scan driver 300 supplies the scan signal V_{S} to the display panel 100 so that the data signal V_{D} can be supplied to a specific pixel in the display panel 100.

The storage unit 400 stores the correction value of an image signal so that the image signal can be corrected in the data driver 200. At this time, an address is specified at each of the pixels in the display panel 100, and the storage unit 400 stores the correction value based on the address. When the data signal V_{D} is generated by receiving the image signal supplied from the data driver 200, it is generated using the correction value stored in the storage unit 400.

FIG. 4 is a circuit diagram of a pixel used in the multivision display device according to an embodiment of the present invention.

Referring to FIG. 4, the pixel is coupled to a data line Dm, a scan line Sn, a light emission control line En and a pixel power source line ELVDD. The pixel includes a first transistor T1, a second transistor T2, a third transistor T3, a capacitor Cst and an organic light emitting diode OLED.

The first transistor T1 has a source electrode coupled to the pixel power source line ELVDD, a drain electrode coupled to a source electrode of the third transistor T3, and a gate electrode coupled to a node N. The second transistor T2 has a source electrode coupled to the data line Dm, a drain electrode coupled to the node N, and a gate electrode coupled to the scan line. The third transistor T3 has the source electrode coupled to the drain electrode of the first transistor T1, a drain electrode coupled to the organic light emitting diode OLED, and a gate electrode coupled to the light emission control line En. The capacitor Cst is coupled between the node N and the pixel power source line ELVDD so that the voltage between the node N and the pixel power source line ELVDD is maintained for a predetermined period of time. The organic light emitting diode OLED includes an anode electrode, a cathode electrode and a light emitting layer. The anode electrode is coupled to the drain electrode of the third transistor T3, and the cathode electrode is coupled to a low-potential power source ELVSS. If current flows from the anode electrode to the cathode electrode, light is emitted from the light emitting layer, and the brightness of light is controlled based on the amount of current.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A multivision display device comprising:
a first display panel having a first light emitting area and a first non-light emitting area formed around the first light emitting area; and
a second display panel having a second light emitting area and a second non-light emitting area formed around the second light emitting area, the first and second display panels being overlapped with each other so that the first and second light emitting areas are adjacent to each other about a reference line with a portion of the second non-light emitting area overlapping a first area of the first light emitting area.

2. The multivision display device according to claim 1, the luminance of the first area being controlled to be higher than that of a remaining second area of the first light emitting area.

3. The multivision display device according to claim 1, further comprising a data driver for supplying data signals to the first and second display panels, a gray scale of the data signals inputted to the first area being controlled to be higher than that of the remaining data signals.

4. The multivision display device according to claim 3, further comprising a storage unit for storing correction values of an image signal and supplying the correction values to the data driver, the data driver generating enhanced data signals in response to the correction values, the enhanced data signal being provided to the pixels in the first area.

5. The multivision display device according to claim 4, the storage unit operating when a high gray scale is expressed at the first area so that the correction values are supplied to the data driver.

6. A driving method for a multivision display device, comprising:
supplying an image signal to a display panel, the display panel comprising a first display panel having a first light emitting area and a first non-light emitting area, and a second display panel having a second light emitting area and a second non-light emitting area;
partially overlapping the first and second display panels, thereby forming a first area on the first display panel overlapped by the second non-light emitting area;
determining a degree at which a luminance of the first area is reduced by the second display panel and, in response to the determination, generating a correction value of the image signal; and
applying the correction value to the image signal for generating an enhanced data signal to be applied to pixels in said first area.

7. The driving method according to claim 6, the correction value being applied when a high gray scale is expressed at the first area.

8. The driving method according to claim 6, the enhanced data signal having an increased luminace value compared to a remaining second area of the first light emitting area.
